(19) United States
(12) Patent Application Publication
(10) Pub. No.: US 2026/0231923 A1
(43) Pub. Date: Aug. 13, 2026

(54) APPARATUS AND METHOD FOR SAFE FISH HANDLING AND RELEASE

(71) Applicant: UNIVERSITY OF FLORIDA RESEARCH FOUNDATION, INCORPORATED, Gainesville, FL (US)

(72) Inventors: Victor Juan BLANCO MARQUEZ, Gainesville, FL (US); Pedro A MORA-IZTURRIAGA, Gainesville, FL (US); Daniel HOFSTETTER, Gainesville, FL (US)

(21) Appl. No.: 19/460,858

(22) Filed: Jan. 27, 2026

Related U.S. Application Data
(60) Provisional application No. 63/756,374, filed on Feb. 10, 2025.

(51) Int. Cl. A01K 97/18

(52) U.S. Cl. CPC A01K 97/18

(57) ABSTRACT

The present disclosure relates to an apparatus and method to mitigate barotrauma, and more particularly, to use of a device that provides various innovative functions associated with releasing fish from fishing hooks, holding fish at surface, and returning a fish at depth safely with data logging and image capture capabilities. Embodiments provided herein include an apparatus for releasing fish at depth including: a body; a hook movable between a stowed position and a deployed position relative to the body; a needle movable between a stowed position and at least one deployed position relative to the body; a weight; and a weight receiver, where the body defines a first end and a second end, where the hook in the deployed position extends from the first end of the body, and where the weight receiver is disposed at the second end of the body, opposite the first end.

### CROSS-REFERENCE TO RELATED APPLICATIONS

This application claims priority to U.S. Provisional Patent Application Ser. No. 63/756,374, filed on Feb. 10, 2025, the contents of which are hereby incorporated by reference in their entirety.

### TECHNOLOGICAL FIELD

The present invention relates to fish handling and release devices to mitigate barotrauma, and more particularly, to an apparatus and method of use of a device that provides various innovative functions associated with handling fish at the surface and releasing a fish at depth safely with data logging and image capture capabilities.

### BACKGROUND

Fishing is an ancient occupation and pastime historically performed to feed a populous. In more modern times, fishing has become an important recreational hobby as well as an important tool for research, particularly in establishing the health of the fish population of various species as they suffer from over-fishing and loss of livable habitat through pollution and temperature changes. With recreational fishing and research, it is common to release fish after catch to return them to their habitat to maintain the health of the population and comply with seasonal and size regulations. However, fish that are caught and brought to the surface from deeper waters can suffer from barotrauma as the fish ascends in the water column and experiences a rapid pressure change. With the decrease of the pressure of the environment of a fish, the swim bladder can expand, the intestines and stomach can expand, and the eyes can bulge. Each of these signs of barotrauma can jeopardize the health of the fish.

Simply returning a fish to the water that has experienced some degree of barotrauma results in a high mortality rate of the fish as they are not able to properly recover from the barotrauma or descend as they require, making them more susceptible to predation. It is recommended to return a fish that has experienced barotrauma to a depth approximating the depth from which the fish was recovered. Such a deep-water return significantly increases the likelihood of survival of the fish after release.

### BRIEF SUMMARY

Provided herein is an apparatus and method to mitigate barotrauma, and more particularly, to an apparatus and method of use of a device that provides various innovative functions associated with handling a fish at surface and releasing a fish at depth safely with data logging and image capture capabilities. Embodiments provided herein include an apparatus for handling a fish at surface and releasing fish at depth including: a body; a multifunction hook movable between a stowed position and a deployed position relative to the body; a venting needle movable between a stowed position and at least one deployed position relative to the body; a weight, where the body defines a first end and a second end, where the hook in the deployed position extends from the first end of the body, and where the weight is disposed at the second end of the body, opposite the first end; and a weight body that can be integrated to the main body.

The apparatus of some embodiments further includes a needle actuator, where the venting needle is moved from the stowed position to at least one deployed position via the needle actuator. The venting needle of some embodiments movable between the stowed position and any adjustable deployed position, where the needle actuator defines adjustable positions. According to certain embodiments the adjustable positions defined by the needle actuator are each associated with a respective detent.

According to some embodiments the venting needle defines a lumen through the needle, where a base of the needle defines venting holes in fluid communication with the lumen through the needle. According to certain embodiments the hook is movable about a pivot point from the stowed position substantially within the body to the deployed position extending from the first end of the body. The weight of an example embodiments includes a connector to which the body is secured, wherein the weight is selected based on a size of fish to be released.

The apparatus of some embodiments further includes a bracket extending from the body, wherein the bracket is configured to receive an underwater camera housing. The apparatus of some embodiments further includes a data logger, where the data logger is configured to track descent of the apparatus through water to a release depth of a fish. The hook of an example embodiment defines a loop, where in the deployed position, the loop is at a furthest point from the body on the hook, which is used to remove fishing hooks from the fish. According to certain embodiments the first end of the body defines a recess, where the recess is configured to receive the hook in the deployed position and resist movement of the hook from the deployed position to the stowed position. The free end of the hook is sharp and is inserted in the fish lip to hold it in an upside position (embodiment above the hook in the deployed position), and descend the fish in the upright position (embodiment below the hook in the deployed position).

Embodiments provided herein include an apparatus for handling a fish at surface and releasing fish at depth including: a body; a hook movable between a stowed position and a deployed position relative to the body; a venting needle movable between a stowed position and at least one deployed position relative to the body; a weight; and a needle actuator where the venting needle is moved from the stowed position to at least one deployed position via the needle actuator, where the venting needle is movable between the stowed position and different adjustable deployed positions, and where the needle actuator defines multiple positions.

According to some embodiments the body defines a first end and a second end, where the hook in the deployed position extends from the first end of the body. The hook of an example embodiment defines a loop, where in the deployed position, the loop is at a furthest point from the body on the hook. According to some embodiments the hook is movable about a pivot point from the stowed position substantially within the body to the deployed position extending from the first end of the body.

According to certain embodiments the first end of the body defines a recess, where the recess is configured to receive the hook in the deployed position and resist movement of the hook from the deployed position to the stowed position. The body end (cap) is turned sideways to lock the hook in the deployed position. The apparatus of some embodiments further includes a weight, where the weight is attached to the body at the second end. According to certain embodiments the at least two positions defined by the needle actuator are each associated with a respective detent. The venting needle of an example embodiment defines a lumen through the needle, where a base of the needle defines venting holes in fluid communication with the lumen through the needle. The apparatus of some embodiments further includes a bracket extending from the body, wherein the bracket is configured to receive an underwater camera housing.

### BRIEF DESCRIPTION OF THE DRAWINGS

Having thus described the invention in general terms, reference will now be made to the accompanying drawings, which are not necessarily drawn to scale, and wherein:

FIG. 1 illustrates a device for reducing barotrauma according to an example embodiment of the present disclosure;

FIG. 2A-2C illustrate a device for reducing barotrauma with a hook movable between a stowed and a deployed position according to an example embodiment of the present disclosure;

FIG. 3 illustrates a perspective view of the first end of a device for reducing barotrauma according to an example embodiment of the present disclosure;

FIG. 4 illustrates a hook for removing a fishing hook, for holding a fish at surface, and for descending a fish for deep water release according to an example embodiment of the present disclosure;

FIG. 5A-5C illustrate a device for reducing barotrauma with a venting needle movable between a stowed position and a deployed position according to an example embodiment of the present disclosure;

FIG. 6 illustrates a method of use of a device to reduce barotrauma according to an example embodiment of the present disclosure;

FIG. 7 illustrates a block diagram of a controller that can be specifically configured to perform the operations described herein according to an example embodiment of the present disclosure; and

FIG. 8 illustrates a holster configured to hold a device for reducing barotrauma in fish according to an example embodiment of the present disclosure.

### DETAILED DESCRIPTION

Example embodiments of the present disclosure now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Embodiments of the present disclosure generally relate to a fishing device that provides various functions particularly aimed to mitigate barotrauma in fish that are released after catch. The apparatus of example embodiments described herein provides an all-in-one solution that can facilitate deep-sea release of a fish while also being capable of venting the swim bladder, retrieving the fishing hook from a fish, holding the fish at the surface, providing data logging of the release, and capturing images of the release to help monitor health of the released fish.

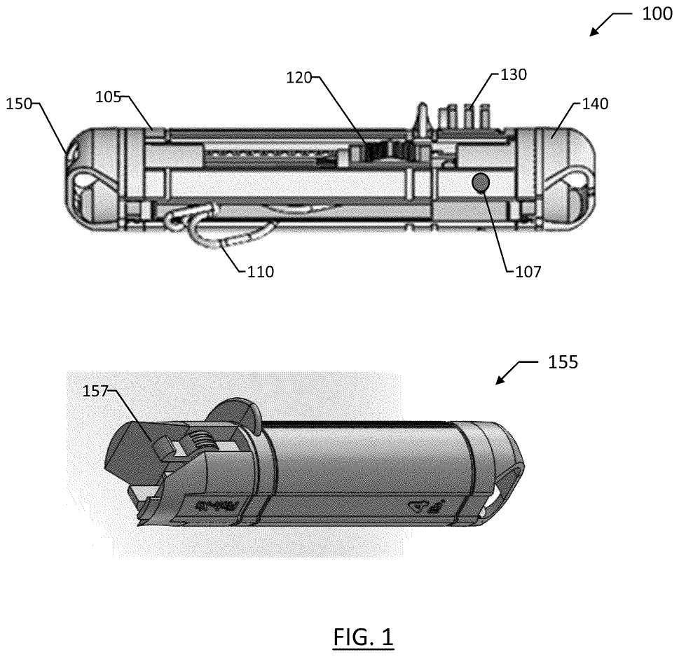

FIG. 1 illustrates a side view of an example device 100 with the features of the device provided in the stowed positions to facilitate easy storage of the device and safe retrieval of the device by a user when the need arises. The body 105 of the device 100 defines a first end 140 and a second end 150, both with rotating capabilities to lock other elements of the embodiment. Visible in the embodiment of FIG. 1 is a release hook 110 in the folded, stowed position substantially within a body 105 of the device 100. The body 105 of the device can be made of a durable plastic, such as an ABS (Acrylonitrile Butadiene Styrene) plastic. The body 105 can be made of other materials; however, a plastic is highly desirable due to the high corrosion resistance, positive buoyancy, and low cost along with being readily molded into various form factors. The first end 140 and second end 150 can be preferably made of non-corrosive and low weight metals, like stainless steel or similar.

The illustrated device 100 of FIG. 1 also includes a venting needle actuator 120, detailed further below for deploying a venting needle from a stowed position to at least one deployed position. A camera mount 130 is provided that is configured to attach to a small waterproof camera housing that carries an action camera. The camera can be used to record and/or stream video of the fish descent and release along with monitoring the health of the fish immediately after release. The device 100 may further include a user-interface element, such as an LED 107 (light emitting diode) or LCD screen, for example. While such an element is not necessary for basic functionality of the device, embodiments may be enabled with “smart” communication features to communicate with an app or otherwise provide information to a user of the device as described further below.

FIG. 1 also illustrates a weight 155 that is configured with a connector 157 which can be releasably attached to the second end 150. The weight 155 has a negative buoyancy, which may include a heavy mass such as lead or other dense material within a body of the weight. The illustrated device 100 of FIG. 1 is complemented with the weight 155 which can be attached directly to the device 100 by connecting second end 150 of the device with the connector 157 of the weight 155 as a quick connect-disconnect system to form an integrated unit.

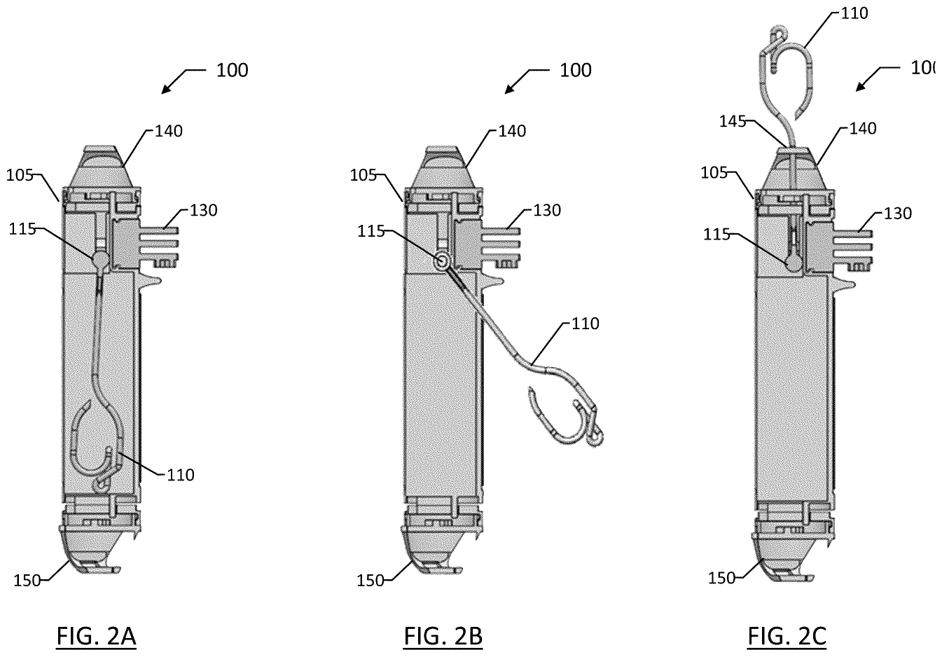

FIGS. 2A-2C illustrate section views of the device 100 in an upright position illustrating the deployment of the hook 110 from the stowed position shown in FIG. 2A to the fully deployed position shown in FIG. 2C. As shown, in the stowed position of FIG. 2A, the hook 110 is received within the body 105. According to some embodiments, a portion of the hook 110 is accessible in the stowed position for a user to manipulate to begin movement of the hook to the deployed position.

As shown in FIG. 2B, the hook 110 has been moved from the stowed position to a partially deployed position through rotation about pivot point 115 within the body of the device 100. The hook 110 can continue to be rotated about the pivot point 115 to reach the fully deployed position of FIG. 2C. In the fully deployed position, the hook 110 may be received within a recess 145 of the first end 140 of the body 105. The first end 140 rotates 90 degrees clockwise or counterclockwise to lock the hook in position and can provide stability for the hook 110, as the hook may be used for release of a relatively heavy fish, such that the recess can stabilize the hook 110 as a fish is hooked onto the hook before being placed into the water for safe release. The recess 145 of an example embodiment can optionally include a detent or retention feature that helps to retain the hook 110 in the deployed position shown in FIG. 2C. This feature may include, for example, a narrow neck within the recess through which the hook 110 is pressed to reach the fully deployed position, and which requires force to be pressed through to move out of the fully deployed position. Such a retention feature can help the hook to avoid pivoting away from the deployed position during deep water release as will be described further below.

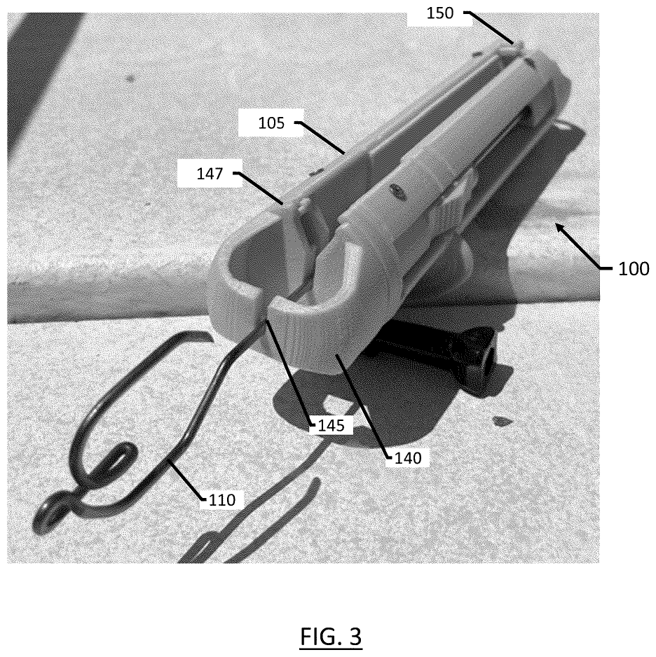

FIG. 3 illustrates a perspective view of the device 100 from the first end 140. As shown, the hook 110 extends through recess 145 which provides stability to the hook. The first end 140 rotates 90 degrees clockwise or counterclockwise to lock the hook in position The recess 145 of an example embodiment further includes a retention feature to retain the hook in the deployed position until deliberately moved toward the stowed position by a user. In lieu of or in addition to a detent to retain the hook 110 in the deployed position, embodiments may optionally employ a rotational locking feature. This feature may include a locking ring, such as a collar 147 that is disposed about the device with an opening to allow the hook 110 to move to the deployed position, but can be thereafter rotated to preclude the hook 110 from returning to the stowed position. In some embodiments, the first end 140 of the device 100 may be rotatable relative to the body 105, such that rotation of the first end 140 causes the recess 145 to move out of alignment with a path along which the hook 110 would fold toward the stowed position. Such rotation of the first end 140 would lock the hook 110 in the deployed position while also providing a support for the hook along a shaft of the hook to reduce the likelihood of bending.

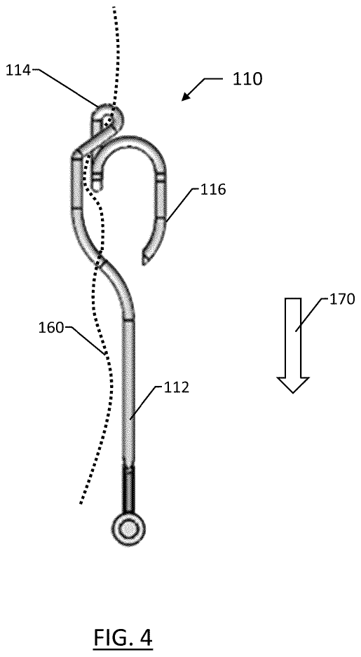

FIG. 4 illustrates an example embodiment of the hook 110 without the device 100 for ease of understanding. As shown, the hook 110 includes a shaft 112, a loop 114, and a hook end 116. The hook 110 is designed to not only provide a deep water release hook, but also to function as a fishing hook removal tool, and a surface fish holding tool. The loop 114 provides the fishing hook removal function when used as described herein along with providing the fishing line attachment point for deep water release of the fish.

A fish that ingests a hook within the mouth may have ingested the hook too far to be easily removed by hand. Alternatively, in some species of fish the teeth can be very sharp such that an angler does not want to manually remove the fishing hook by hand. To safely remove the hook and to remove a hook that is ingested within the mouth of a fish, the fishing line can be looped over the shaft 112 and pulled down through the loop 114 to a path depicted by dotted line 160. This provides an easy way to feed the fishing line into the loop 114 without requiring a high degree of dexterity which may be challenging for a gloved angler or on a moving vessel. Once the fishing line is fed through the loop 114, the hook 110 may be fed loop-first into the mouth of the hooked fish, toward the fishing hook. The loop 114 can then engage the fishing hook and follow a length of the fishing hook to forcibly push the flesh of the fish off of the fishing hook, thereby freeing the fishing hook for removal.

The hook end 116 portion of the hook 110 is a non-barbed hook end that is configured to be sharp enough to pierce the lip of a fish for a temporary attachment during descent of the device or to hold the fish at surface while in an upside-down position of the device 100. The hook end 116 is designed to retain a fish on the hook 110 as the hook moves in the direction of arrow 170 within the water, but to release the fish when the hook 110 is pulled in the opposite direction of arrow 170.

The hook 110 of an example embodiment can further be used for holding a fish at the water surface, such as by holding the body 105 with the hook 110 at the bottom, a fish is held on the hook by its weight. The fish can be held in the water in a similar manner as necessary before the fish is descended for deep water release.

Mitigating barotrauma by releasing a fish at depth reduces the likelihood of mortality of the fish; however, additional steps can be taken to mitigate barotrauma and improve survivability. A fish that has experienced a relatively rapid ascent to the surface while being reeled in can experience bloat from the significant reduction in pressure over a short amount of time. This bloat can be caused in part by the swim bladder expanding with the pressure drop. Relieving the bloat from the swim bladder through puncturing and venting can improve the likelihood of fish survival upon return to the water as the bloat of the swim bladder not only causes fish buoyancy, but also puts pressure on the other organs of the fish.

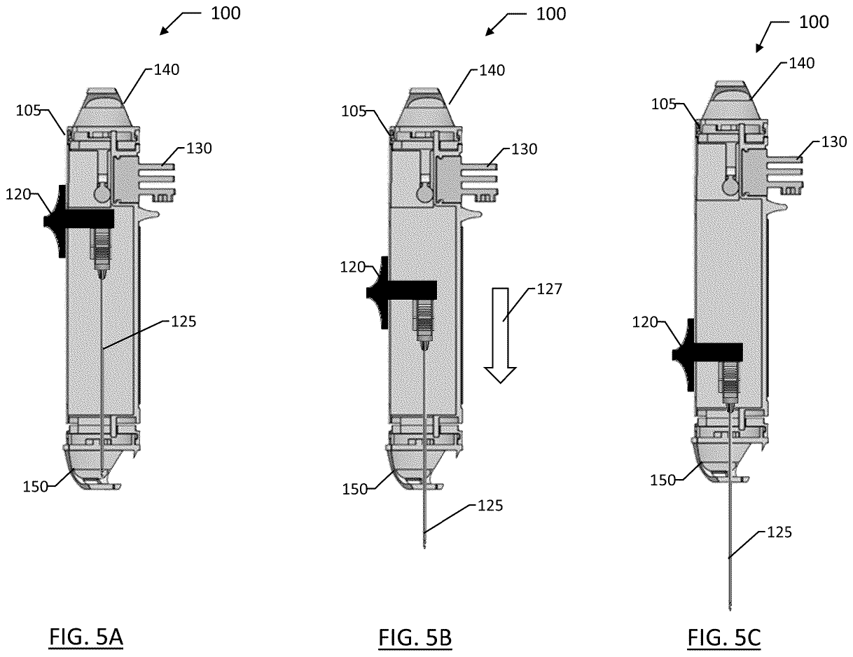

Embodiments of the device described herein provide a mechanism for venting the swim bladder of a fish to improve survivability of a deep water release. FIGS. 5A-C illustrate a deployable heavy duty venting needle 125 that can be extended to safely pierce the fish and release air accumulated during catching from the swim bladder to relieve barotrauma. As shown, the needle 125 includes a needle actuator 120 that can be depressed to extend or retract the needle 125. Detents molded into the sides of the needle channel can be formed to stop the needle 125 at various lengths for different sizes of fish. The positions of the needle actuator 120 can be marked on a side of the body 105 to indicate depth of extension of the needle 125.

According to some embodiments an end cap at the second end 150 of the device 100 can include a needle aperture and can be rotatable relative to the body 105 of the device. The needle aperture within the end cap at the second end 150 may require alignment with an axis along which the needle is deployed in order to deploy the needle 125. This can preclude inadvertent deployment of the needle 125. The aperture may also provide support for a deployed needle 125, whereby the aperture provides a support to limit or preclude bending of the needle during use.

FIG. 5A illustrates the needle 125 within the body 105 in the stowed position. In an embodiment with an end cap and needle aperture, the needle aperture may require rotation to align with the needle 125 before deployment can begin. Upon such alignment, the needle 125 may be deployed by a user by pressing on needle actuator 120, moving the actuator in the direction of arrow 127 as shown in FIG. 5B. The needle 125 may have more than one deployed position to provide for different lengths of extension of the needle from the second end 150 of the device 100. FIG. 5B illustrates a first deployed position, where the needle 125 or needle actuator 120 may have reached a detent within the body 105. FIG. 5C illustrates a second deployed position where the needle actuator 120 is moved to the extent of its range of travel providing a maximum length of extension of the needle 125 for venting of a fish that has experienced barotrauma.

The needle 125 of an example embodiment includes a lumen through the needle to allow air to pass through a central axis of the needle. The needle's tip of an example embodiment is closed in a cone shape, with the openings connecting to the lumen of the needle only on the sides to avoid obstruction of the lumen by fish flesh. The needle base may include one or more ventilating holes that extend from outside the needle base and are in fluid communication with the lumen of the needle. These ventilating holes permit air released from the fish through the lumen and out the ventilating holes to reduce bloat of the fish. Further, the ventilating holes may permit any flesh that may have entered the lumen of the needle 125 from the fish to be cleared from the lumen to not preclude airflow from the fish through the lumen. The needle 125 of an example embodiment may be replaceable, such as removable from the needle actuator 120 and replaced as needles may become clogged or bent over time.

The second end 150 of the body 105 of the device 100 further includes an attachment point, whereby weight 155 can be attached to the attachment point. The weight is used to ensure the device 100 descends within the water to reach the appropriate release depth for the fish. The release depth will generally approximate the depth at which the fish was initially hooked or at least 30 ft depth. The weight 155 that is attached to the device may depend upon both the release depth and the size of the fish to be released. A larger fish would generally require a larger weight. However, a weight that is too large may also be undesirable as it may move through the water too quickly and potentially injure the fish that is being pulled via the hook 110. While the weight 155 of FIG. 1 can be used, additional weight can be added as necessary using one or more additional weights secured to the second end 150 of the device body 105 or to an end of the weight 155.

The body 105 of the device 100 may also include an attachment point, recess, or cavity for a datalogger that can be inserted into the device to allow various measurements to be recorded when descending the fish. An example data logger can measure depth, water temperature, salinity, coordinates, etc. with timestamps such that a depth profile can be made along with a profile of the descent and release of the fish.

The camera mount 130 of the illustrated embodiments can be of a standard mount base that is adapted to receive a camera housing, such as a waterproof camera housing for a camera that can record still images or video, and optionally can provide a live stream of the descent and release to a video display on the vessel from which the fish is being released.

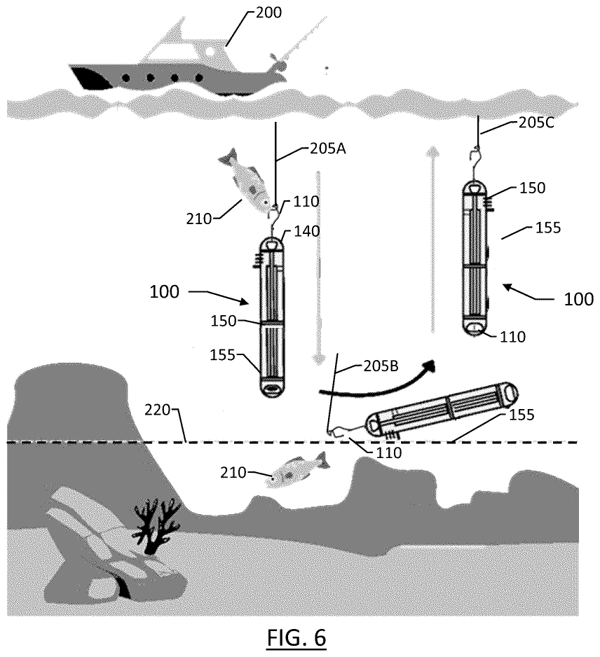

According to an example embodiment described herein, a method of use of the device will now be described with reference to FIG. 6 and the device 100 of FIGS. 1-5. A fish that is caught at depth and brought to the surface can experience barotrauma. Once on the vessel 200 and barotrauma is recognized, the angler may take action to limit the trauma to the fish. The device 100 can be retrieved, such as from a specifically designed holster on a deck of the vessel 200, and a needle deployed. The needle 125 may require turning of an end cap at the second end 150 of the device 100 to align a needle aperture with the needle as described above. The needle actuator 120 can be manipulated by the angler to deploy the needle 125 to the appropriate deployed position depending upon a size of the fish. Once the fish has been vented with the needle 125 and the air from the fish released, the needle may be retracted to the stowed position within the body 105 of the device.

If not already attached to the device body 105, a weight 155 can then be attached to the second end 150 of the device 100 sufficiently heavy sized for the fish 210, and a line 205 attached to the loop 114 of the hook 110 of the device 100. The line 205 may be fishing line of a rod and reel or optionally a hand-fed line separate from a fishing rod. The angler may then hook the hook end 116 of the hook 110 through a lip of the fish. The fish 210 may then be placed into the water from the vessel 200. The line (shown as line 205A in FIG. 6) is then let out as the weight 155 sinks the fish into the water. The line may be marked at a certain length to ensure an appropriate depth is reached. Importantly, the weight 155 is allowed to substantially free-fall within the water to ensure the orientation of the device is maintained with the first end 140 above the second end 150 (upright position), which maintains the hook 110 within the lip of the fish 210. Optionally, the datalogger may report back to a display on the vessel of a depth of the device 100 to ensure appropriate depth is reached. Optionally, the release depth may be a seafloor in which case the bottom is known to be reached when the line 205A ceased to be pulled into the water.

Once the release depth 220 is reached, the angler may then apply upwards (towards the surface) tension to the line shown as line 205B in FIG. 6. This removes hook end 116 of the device 100 from the fish lip and causes the fish 210 to be released from the hook 110. The upward movement of the hook 110 as pulled by the line 205 pulls the hook 110 from the mouth of the fish 210 as the shape of the hook is specifically configured to allow the fish to easily be removed and there is no barb on the hook to retain the fish. The line shown as 205C is then pulled to return the device 100 to the surface and to the vessel 200 with the fish 210 safely released at depth. The device 100, safely returned to the vessel 200. Alternatively, the device can be used to analyze the release. Such as by reviewing video footage from the underwater camera and/or reviewing data from the datalogger if these signals were not already wirelessly transmitted to the vessel.

The device of example embodiments can be a simple device devoid of electronics in some embodiments while still providing valuable features for reducing the effects of barotrauma on a fish caught at depth. However, some example embodiments employ a user interface that allows a user to communicate with the device 100 to provide improved performance and understanding of the device status and functionality.

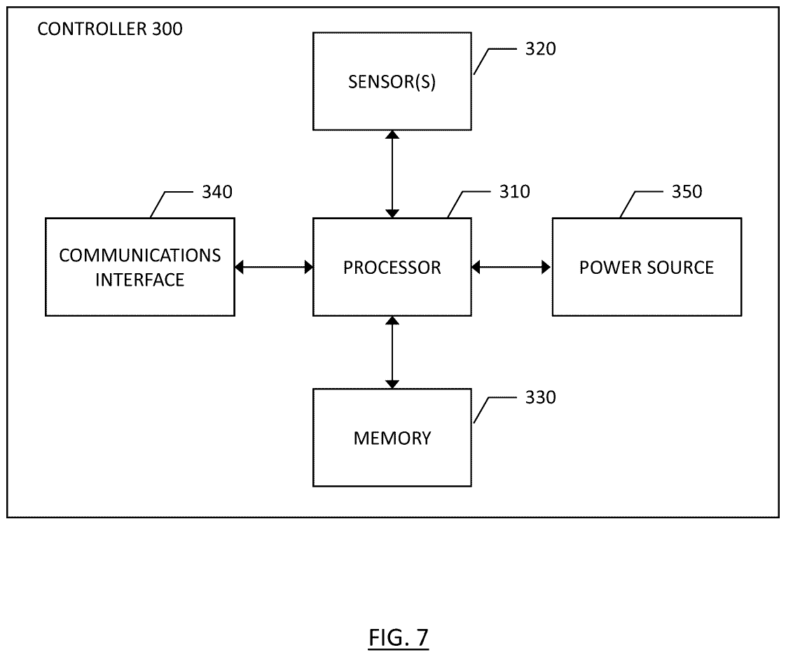

FIG. 7 illustrates an example embodiment of a controller that can be specifically configured to perform the operations described herein. FIG. 7 illustrates a schematic diagram of an example controller which is implemented to perform the functions of the fish release device described herein. As shown, the controller 300 is embodied by or associated with any of a variety of computing devices that include or are otherwise associated with a drift buoy. According to an example embodiment, the computing device is a controller which at least partially controls communications, sensor readings, and data collection for a deep water fish release device. These features are not necessary for all such devices 100, and some embodiments employ only a portion of the functionality described herein, while other embodiments employ a greater level of functionality than described herein.

The controller 300 of an example embodiment is equipped with any number of sensors 320, such as temperature sensors, pressure sensors, location sensors, recovery sensor, etc. Position tracking or locating of the controller 300 of an example device can be accomplished using satellite localization. While global positioning systems (GPS) and cellular technologies used for terrestrial navigation may be useful near land (e.g., coastal waters, inland lakes, intercoastal waterways, etc.), embodiments described herein can employ a satellite service with coverage of seas, such as the Iridium^{TM} satellite communications network. These sensors are optionally used to sense information regarding the movement, positioning, or orientation of the device for use in localization and/or to facilitate tracking of fish release events as described herein according to example embodiments.

The controller 300 of an example embodiment includes, is associated with, or is otherwise in communication with a communications interface 340, processor 310, sensor(s) 320, and/or a memory 330. In some embodiments, the processor 310 (and/or co-processors or any other processing circuitry assisting or otherwise associated with the processor) is in communication with the memory device via a bus for passing information among components of the controller. The memory 330 of an example embodiment is non-transitory and includes, for example, one or more volatile and/or non-volatile memories. In other words, for example, the memory is an electronic storage device (for example, a computer readable storage medium) including gates configured to store data (for example, bits) that are retrievable by a machine (for example, a computing device like the processor). The memory 330 of an example embodiment is configured to store information, data, content, applications, instructions, or the like for enabling the controller to carry out various functions in accordance with an example embodiment of the present disclosure. For example, the memory device is configured to buffer input data for processing by the processor. Additionally or alternatively, the memory 330 is configured to store instructions for execution by the processor.

The processor 310 of example embodiments is be embodied in a number of different ways. For example, the processor of an embodiment is one or more of various hardware processing means such as a microprocessor, a controller, a digital signal processor, or other processing circuitry including circuits such as an application specific integrated circuit, a field programmable gate array, a microcontroller unit, or the like.

The controller 300 of example embodiments includes a communication interface 440 that includes any means such as a device or circuitry embodied in either hardware or a combination of hardware and software configured to receive and/or transmit data to/from other electronic devices, such as communicating between a fishing device and a computer aboard a vessel. The communication of an example embodiment is performed over any available communication protocol, such as near field communication for certain functionality, cellular communication, sonar, Global System for Mobile Communications (GSM), or the like. Embodiments optionally include a satellite communication protocol using short data burst packets, such as using the Iridium satellite communications network.

A power source 350, such as a battery may be employed to permit operation of the controller and to facilitate communication from the device. The battery may be sealed within a housing and wirelessly charged to avoid a potential water intrusion point in the housing. This battery may provide the necessary power to communicate via communications interface 340 and to power any user interface components of the device, such as an LED (light emitting diode) or LCD (liquid crystal display) that can communicate device status to a user.

A device employing a controller, such as controller 300 of FIG. 7, can operate in various states. When turned on, the device can begin attempting to communicate, such as via communications interface 340, with a computer or mobile device employing an application configured to interface with and provide information relating to the device. Embodiments may not require communication with a computer or mobile device and can retain functionality even when a communication session with an application is not established.

Embodiments of the device 100 described above can remain powered off to conserve battery life until such time as the device is needed. The device may be powered on by a button or other switch or command that indicates the device is to be used. An LED on the body 105 of the device 100 (e.g., LED 107) may turn on to indicate that the power-on command was received, and the LED may illuminate a particular color to indicate the device is powered-on. The LED may also communicate, such as through flashing, that the device 100 is attempting to synchronize with an application on a remote device via communications interface 340. If connection is made, the LED may indicate as such by ceasing to flash or by turning a different color such as green.

Once the device 100 is powered on, the device may be enabled through a user interface such as a button, or the device may be enabled for use through a movement (e.g., shaking) which may be detected by a sensor 320, such as an accelerometer or inertial measurement unit (IMU). When the device is enabled, an LED may change to a different color (e.g., blue) to signify such enablement.

Once enabled, the device 100 is ready to be used to release a fish at depth. A weight and a fish may be attached to the device as described above to begin the release process, and the enabled device can then be placed into the water for descent. As the device 100 descends, the LED may change color to represent an active descent, and may communicate, such as via communications interface 340, a depth at which the device reaches. The device 100 can also indicate via the sensor(s) 320 active descent and ascent. Upon reaching the desired depth for release, the user may tension the line and pull the device upwardly, as shown with line 205B in FIG. 6. Orientation changes of the device can be established via the sensor(s) 320 such as accelerometer, IMU, or gyroscope to confirm the orientation of the device for effective release of the fish. During the release process, data is collected from the sensor(s) and logged, such as in the app or onboard the device (e.g., in memory 330). When the device exits the water, the data logging may cease and the data from the release process may be saved to memory and/or communicated to a computer or mobile device for viewing.

According to some embodiments, the line used to descend the fish for release may include a wired connection to the controller 300 such that live, active monitoring can be performed. In such an embodiment, the wired connection may optionally be used for a live video feed from the device to view the descent and to confirm safe release at the desired depth.

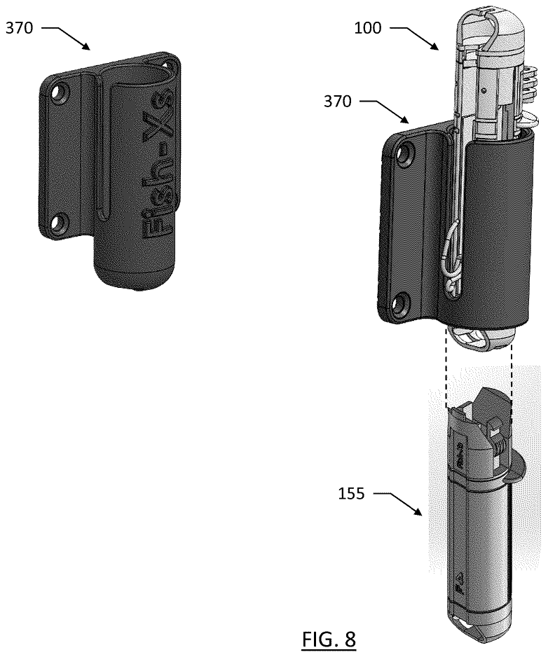

FIG. 8 depicts an example embodiment of a holster 370 configured to receive therein the device 100 described above. The holster 370 may be configured to be secured, such as via fasteners and/or adhesive to a vessel accessible to an angler fishing from the vessel. Having the device 100 readily available to take swift action upon a fish being recovered that is experiencing barotrauma provides the best chances at a positive outcome for the fish. This holster 370 provides that ready accessibility to better utilize the device 100 of example embodiments. The holster may be equipped with a wireless charging feature to enable the device 100 to be wirelessly charged when received within the holster 370. In such an embodiment, the holster 370 may include a wired connection to receive power in order to provide the wireless charging.

The holster 370 of an example embodiment can optionally be configured to receive the device 100 with the weight 155 attached. The holster can additionally or optionally provide a separate attachment point or connector to which the weight 155 may be attached. The weight 155 may be one of several weights having different masses, such that a weight 155 may be chosen based on a size of fish to be released and/or a depth at which the fish is to be released.

Embodiments described herein provide an apparatus and method for mitigating barotrauma in fish caught at depth by providing a multi-function device that can be used to perform all tasks related to releasing, holding, and returning the fish to the depths with minimal barotrauma and an increased likelihood of survival.

Many modifications and other embodiments of the inventions set forth herein will come to mind to one skilled in the art to which these inventions pertain having the benefit of the trainings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus for releasing, holding, and returning fish at depth comprising:
a body;
a hook movable between a stowed position and a deployed position relative to the body;
a needle movable between a stowed position and at least one deployed position relative to the body; and
a weight;
wherein the body defines a first end and a second end, wherein the hook in the deployed position extends from the first end of the body, and wherein the weight is disposed at the second end of the body, opposite the first end.

2. The apparatus of claim 1, further comprising a needle actuator, wherein the needle is moved from the stowed position to at least one deployed position via the needle actuator.

3. The apparatus of claim 2, wherein the needle is movable between the stowed position and at least two deployed positions, wherein the needle actuator defines at least two positions corresponding to the at least two deployed positions.

4. The apparatus of claim 3, wherein the at least two positions defined by the needle actuator are each associated with a respective detent.

5. The apparatus of claim 4, wherein the needle defines a lumen through the needle, wherein a base of the needle defines venting holes in fluid communication with the lumen through the needle.

6. The apparatus of claim 1, wherein the hook is movable about a pivot point from the stowed position substantially within the body to the deployed position extending from the first end of the body.

7. The apparatus of claim 1, wherein the body comprises a location to which a weight is secured, wherein the weight is selected based on a size of fish to be released.

8. The apparatus of claim 1, further comprising a bracket extending from the body, wherein the bracket is configured to receive an underwater camera housing.

9. The apparatus of claim 1, further comprising a data logger, wherein the data logger is configured to track descent of the apparatus through water to a release depth of a fish.

10. The apparatus of claim 1, wherein the hook defines a loop, wherein in the deployed position, the loop is at a furthest point from the body on the hook.

11. The apparatus of claim 1, wherein the first end of the body defines a recess, wherein the recess is configured to receive the hook in the deployed position and resist movement of the hook from the deployed position to the stowed position.

12. An apparatus for releasing, holding, and returning fish at depth comprising:
a body;
a hook movable between a stowed position and a deployed position relative to the body;
a needle movable between a stowed position and at least one deployed position relative to the body; and
a needle actuator wherein the needle is moved from the stowed position to at least one deployed position via the needle actuator;
wherein the needle is movable between the stowed position and at least two deployed positions, wherein the needle actuator defines at least two positions corresponding to the at least two deployed positions.

13. The apparatus of claim 12, wherein the body defines a first end and a second end, wherein the hook in the deployed position extends from the first end of the body.

14. The apparatus of claim 13, wherein the hook defines a loop, wherein in the deployed position, the loop is at a furthest point from the body on the hook.

15. The apparatus of claim 14, wherein the hook is movable about a pivot point from the stowed position substantially within the body to the deployed position extending from the first end of the body.

16. The apparatus of claim 15, wherein the first end of the body defines a recess, wherein the recess is configured to receive the hook in the deployed position and resist movement of the hook from the deployed position to the stowed position.

17. The apparatus of claim 13, further comprising a weight, wherein the weight is attached to the body at the second end.

18. The apparatus of claim 12, wherein the at least two positions defined by the needle actuator are each associated with a respective detent.

19. The apparatus of claim 18, wherein the needle defines a lumen through the needle, wherein a base of the needle defines venting holes in fluid communication with the lumen through the needle.

20. The apparatus of claim 12, further comprising a bracket extending from the body, wherein the bracket is configured to receive an underwater camera housing.
